(19) United States
(12) Patent Application Publication
(10) Pub. No.: US 2009/0294193 A1
(43) Pub. Date: Dec. 3, 2009

(54) In-vehicle device

(75) Inventor: Kiyokazu Okuno, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/453,944

(22) Filed: May 28, 2009

(30) Foreign Application Priority Data
May 29, 2008 (JP) 2008-140712

(51) Int. Cl. B60W 10/04; B60W 20/00; G06F 19/00

(52) U.S. Cl. 180/65.265; 701/22; 180/65.21

(57) ABSTRACT

A vehicle includes a motor, which is supplied with electricity from a battery and configured to drive a driving wheel. An event identifying unit identifies an event before the event occurs, the event indicating to decrease or increase a remaining capacity of the battery in the course of a driving operation of the vehicle or after completion of the driving operation. A control instruction unit provides an instruction to an external device for controlling an output power and a workload of the motor according to the identified event before the event ends at the latest.

### CROSS REFERENCE TO RELATED APPLICATIONS

This application is based on and incorporates herein by reference Japanese Patent Application No. 2008-140712 fled on May 29, 2008.

### FIELD OF THE INVENTION

The present invention relates to an in-vehicle device for a vehicle, which includes an electric motor for driving a driving wheel.

### BACKGROUND OF THE INVENTION

A hybrid vehicle includes an engine and a motor each being a power source. In general, a hybrid vehicle performs regenerative braking thereby to generate electricity by using a motor as a generator when the vehicle slows down.

In the regenerative braking, a battery, which is for supplying electricity to the motor, is charged with the electricity generated. The engine is low in the energy efficiency when being operated at low rotation speed. For example, a parallel hybrid vehicle or a power-split hybrid vehicle starts running only with a motor as a power source, and thereafter runs with an engine as a power source after sufficiently increases in speed. In the present operation, the engine can be operated at a relatively high rotation speed, and thereby the engine can be enhanced in the energy efficiency. Thus, a hybrid vehicle is operated with low fuel consumption.

In a hybrid vehicle, a battery is charged by using a generator, which is driven by an engine. According to JP-A-6-217413, a control device detects a voltage of a battery in the beginning of regenerative braking and identifies a charging state of the battery based on the detected voltage. Thereby, the charging state of the battery can be correctly identified with a simple structure. In addition, overcharge and over discharge of the battery can be avoided by controlling the charging operation of the battery using the generator based on the identified charging state. Thus, the battery can be efficiently charged with electricity while being avoided from deterioration.

It is noted that a battery may further supply electricity to another component such as a navigation device in a hybrid vehicle, in addition to supplying electricity to a motor. In such a hybrid vehicle, for example, the navigation device may download map data (geographic information) and the like from an external source after an operation of the vehicle. In this case, the battery needs to supply electricity to the navigation device for the download after the operation of the vehicle. However, in a conventional hybrid vehicle, an engine and a motor are controlled without consideration of electricity supply from a battery to a component such as a navigation device. Therefore, in such a conventional navigation device, the download of the map data or the like cannot be completed when a remaining battery capacity is not enough after an operation of the vehicle. Alternatively, for example, the battery may be charged after an operation of the vehicle. In such a case, a hybrid vehicle may be operated while an output power of the motor is increased, compared with a case where the battery is not to be charged. In a conventional hybrid vehicle, an engine and a motor are operated without consideration or expectation of such a charging operation of a battery.

### SUMMARY OF THE INVENTION

In view of the foregoing and other problems, it is an object of the present invention to produce an in-vehicle device configured to control a remaining capacity of a battery in accordance with a condition of a vehicle.

According to one aspect of the present invention, an in-vehicle device for a vehicle, which includes a motor supplied with electricity from a battery for driving a driving wheel, the in-vehicle device comprises event identifying means for identifying an event before the event occurs, the event being to decrease or increase a remaining capacity of the battery in the course of a driving operation of the vehicle or after the driving operation. The in-vehicle device further comprises control instruction means for providing an instruction to an external control device to control an output power and a workload of the motor according to the identified event before the event ends at the latest.

According to one aspect of the present invention, a computer readable medium comprising instructions being executed by a computer, which is provided in an in-vehicle device for a vehicle, which includes a motor supplied with electricity from a battery for driving a driving wheel, the instructions including a method comprises identifying an event beforehand, the event being to decrease or increase a remaining capacity of the battery in the course of a driving operation of the vehicle or after the driving operation. The method further comprises providing an instruction to an external control device to control an output power and a workload of the motor according to the identified event before the event ends at the latest.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing a navigation device and components connected with the navigation device via an in-vehicle LAN;

FIG. 2 is a block diagram showing a structure of the navigation device;

FIG. 3 is a flow chart of an event processing;

FIG. 4 is a flow chart of an engine-motor control processing;

FIG. 5 is a flow chart of a first engine-motor switching processing; and

FIG. 6 is a flow chart of a second engine-motor switching processing.

### DETAILED DESCRIPTION OF PREFERRED EMBODIMENTS

As follows, an embodiment will be described with reference to drawings.

[Description of Structure]

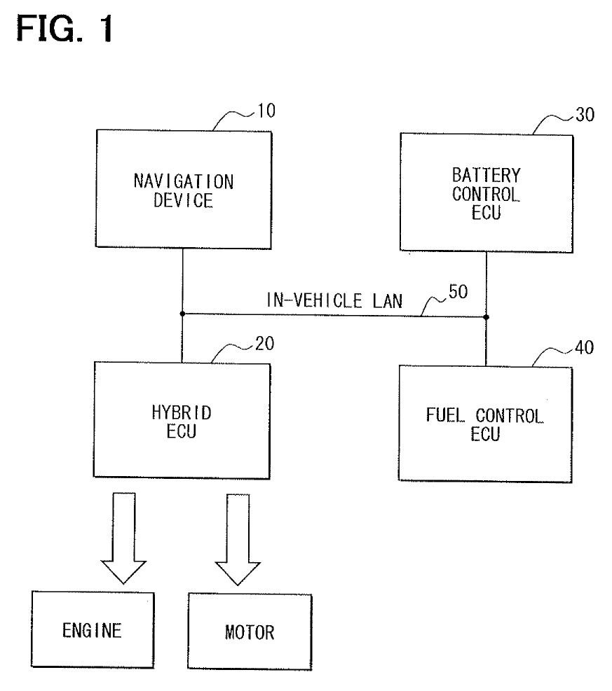

A navigation device 10 according to the present embodiment is provided to a hybrid vehicle, which includes a battery, a motor, a generator, and an engine. The motor is supplied with electric power from the battery for driving a driving wheel. The generator generates electricity and charges the battery with the generated electricity. The engine rotates and drives the generator and a driving wheel. The motor is capable of charging the battery by performing regenerative braking when the vehicle decelerates. FIG. 1 is a block diagram showing a navigation device 10 and components connected with the navigation device 10 via an in-vehicle LAN 50. The navigation device 10 is connected with a hybrid ECU 20, a battery control ECU 30, and a fuel control ECU 40 via the in-vehicle LAN 50. The navigation device 10 may be further connected with other components (not shown) via the in-vehicle LAN 50. In addition to the motor, the battery supplies electricity to the navigation device 10, the hybrid ECU 20, the battery control ECU 30, and the fuel control ECU 40. The battery may further supply electricity to other components (not shown), which are connected with the navigation device 10 via the in-vehicle LAN 50.

The navigation device 10 has a generally-known navigating function such as a routing assistance operation. The navigation device 10 performs an operation to receive a registration of an event from an occupant (user) for decreasing or increasing a remaining capacity (remaining battery capacity) of the battery, which supplies electricity to the motor and the like. The navigation device 10 further performs an operation to control an output power of each of the engine and the motor according to the registered event. The operations will be described later in further details. The hybrid ECU 20 is an electronic control unit for controlling the motor and the engine. The hybrid ECU 20 sets each of an output power (motor output power) of the motor and an output power (engine output power) of the engine for operating the driving wheel. The hybrid ECU 20 distributes the engine output power to a driving power of the driving wheel and a driving power of the generator. The hybrid ECU 20 performs the following operation in a normal running. When the vehicle starts running or runs at a low or middle speed, the engine is low in efficiency. In such a condition of low efficiency, the driving wheel is driven by driving force of the motor. Alternatively, when the vehicle runs at high-speed, the engine output power is distributed to the driving power of the driving wheel and the drive power of the generator so as to maintain the efficiency of the engine at high level. In addition, the motor is driven by electricity generated by the generator, and thereby the driving wheel is driven by the output power of the motor. When the vehicle quickly accelerates, the driving wheel is driven by both the engine output power and the motor output power. The battery control ECU 30 has a function to identify the remaining battery capacity. The fuel control ECU 40 has a function to identify remaining fuel of the engine.

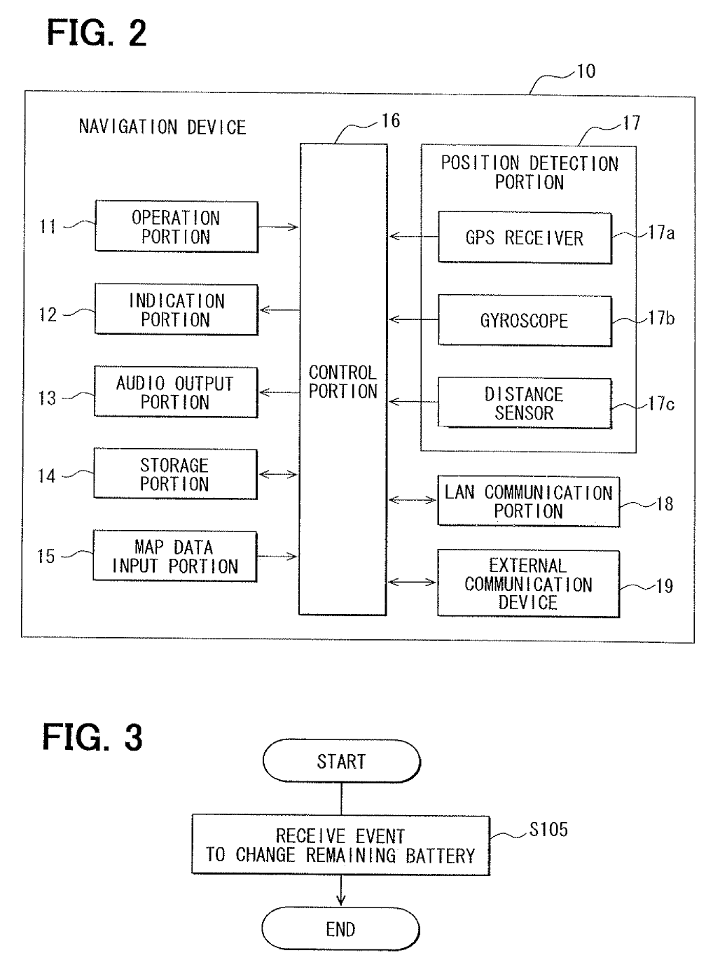

Next, a structure of the navigation device 10 will be described in detail. FIG. 2 is a block diagram showing a detailed structure of the navigation device 10. The navigation device 10 includes an operation portion 11, an indication portion 12, an audio output portion 13, a storage portion 14, a map data input portion 15, a control portion 16, a position detection portion 17, an in-vehicle LAN communication portion 18, and an external communication device 19. The operation portion 11 includes an input device such as a mechanical key switch or a touch switch for receiving various instructions from a user. The indication portion 12 is, for example, a display device such as an LCD device or an organic electroluminescence (EL) device for performing various kinds of indication. The audio output portion 13 is configured to output audio information such as a voice message according to a signal, which is inputted from the control portion 16. The storage portion 14 includes a storage device such as a hard disk drive (HDD) or a flash memory. The storage portion 14 may be configured to store a variety of information without a memory holding operation. The map data input portion 15 inputs map data, which is used in a routing assistance and the like, and various information items, which are used in an information retrieval operation for, for example, searching a predetermined facility. The map data and various information items may include a large volume of data, and therefore may be stored in a DVD-ROM or the like. The control portion 16 is, for example, a generally-known microcomputer, which includes a CPU, a ROM, a RAM, an I/O device, and a bus line, which connects thereamong. The control portion 16 controls each part of the navigation device 10 according to a program stored in the ROM, for example. The position detection portion 17 includes a GPS receiver 17a, a gyroscope 17b, and a distance sensor 17c. The GPS receiver 17a receives an electric wave from a space satellite for a global positioning system (GPS system) via a GPS antenna (not shown) and thereby detects the position of the vehicle, the direction of the vehicle, the speed of the vehicle, and the like. The gyroscope 17b detects a rotary motion of the vehicle. The distance sensor 17c detects a travel distance according to acceleration of the vehicle in the backward and forward direction of the vehicle, and the like. Each of the components has a specific characteristic and has an inherent error. Therefore, the components are used so as to complement to each other. The in-vehicle LAN communication portion 18 is configured to transmit and receive a variety of information items via the in-vehicle LAN 50. The external communication device 19 is configured to perform a wireless communications with a server, for example.

[Description of Processing]

As follows, a processing of the navigation device 10 will be described.

(1) Event Registration Processing

First, a processing of the navigation device 10 for the registration of the event to decrease or increase the remaining battery capacity will be described with reference to a flow chart in FIG. 3. The present processing may be executed when the event is registered by a user in a driving operation or in advance of the driving operation. At a time point (driving start point), the hybrid vehicle receives a command from the user to start the driving operation. Specifically, the driving start point may be a time point at which a portable device or the like is mounted to or inserted into the hybrid vehicle in a smart entry system. Alternatively, for example, the driving start point may be a time point at which a predetermined button is pushed in the hybrid vehicle. At a time point (driving end point), the hybrid vehicle receives a command from the user to terminate the driving operation. Specifically, the driving end point may be a time point at which a portable device or the like is detached from the hybrid vehicle in a smart entry system. Alternatively, for example, the driving end point may be a time point at which a predetermined button is pushed in the hybrid vehicle.

At S105, the control portion 16 of the navigation device 10 receives an event to decrease or increase the remaining battery capacity from a user via the operation portion 11. In the present operation, the storage portion 14 receives the registration of the event from the user by storing an information item, which identifies the present event. Specifically, the present event may be to charge the battery from an external power source after end of the driving operation of the vehicle. At this time, the control portion 16 further receives a position information item (driving end position) at which the driving operation of the vehicle ends. Thus, the present information item is stored in the storage portion 14 as an additional information item. The event may be for a predetermined operation such as download of data from an external source performed by the device of the vehicle using electricity supplied from the battery during the driving operation or after the end of the driving operation. At this time, the control portion 16 further receives an information item for identifying a device, which performs the predetermined operation. Thus, the present information item is stored in the storage portion 14 as an additional information item. When the predetermined operation is to be performed after end of the driving operation, the control portion 16 further receives the driving end position. Thus, the present information item is stored in the storage portion 14 as an additional information item. The event may be to charge the battery performed by regenerative braking of the motor when the vehicle runs on a predetermined road section such as a downward slope. When the charge of the battery performed by regenerative braking is registered as an event, the control portion 16 further receives a predetermined road section, in which the regenerative braking is performed, and a start point and an end point of the predetermined road section. Thus, the present information items are stored in the storage portion 14 as additional information items. Thus, the control portion 16 terminates the present processing after registration of the event.

(2) Engine-Motor Control Processing

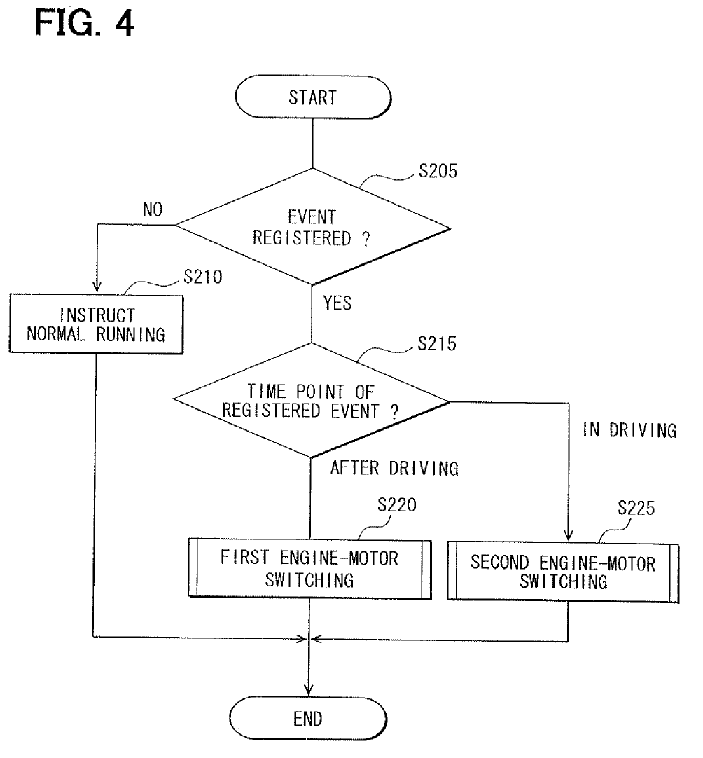

Next, an engine-motor control processing will be described with reference to FIG. 4. The navigation device 10 executes the present engine-motor control processing for controlling the engine output power and the motor output power. The present processing is executed at the driving start point of the vehicle or after the event registration processing is executed in the driving operation of the vehicle.

At S205, the control portion 16 refers to the storage portion 14 and determines whether the event to decrease or increase the remaining battery capacity is registered. When the event is registered, a positive determination is made at S205, and the control portion 16 proceeds the processing to S215. Alternatively, when the event is not registered, a negative determination is made at S205, and the control portion 16 proceeds the processing to S210.

At S210, the control portion 16 instructs the hybrid ECU 20 to perform the normal running via the in-vehicle LAN communication portion 18, and thereafter the present processing is terminated. When the event is registered, the processing proceeds to S215 at which the control portion 16 determines an occurrence time point of the registered event. When the occurrence time point of the event is after the driving operation, the control portion 16 proceeds the processing to S220. Alternatively, when the occurrence time point of the event is in the driving operation, the control portion 16 proceeds the processing to S225.

At S220, the control portion 16 executes a first engine-motor switching processing. The control portion 16 terminates the present processing in response to the end of the first engine-motor switching processing. When the occurrence time point of the registered event is in the driving operation, the processing proceeds to S225 at which the control portion 16 performs a second engine-motor switching processing. The control portion 16 terminates the present processing in response to the end of the second engine-motor switching processing.

(3) First Engine-Motor Switching Processing

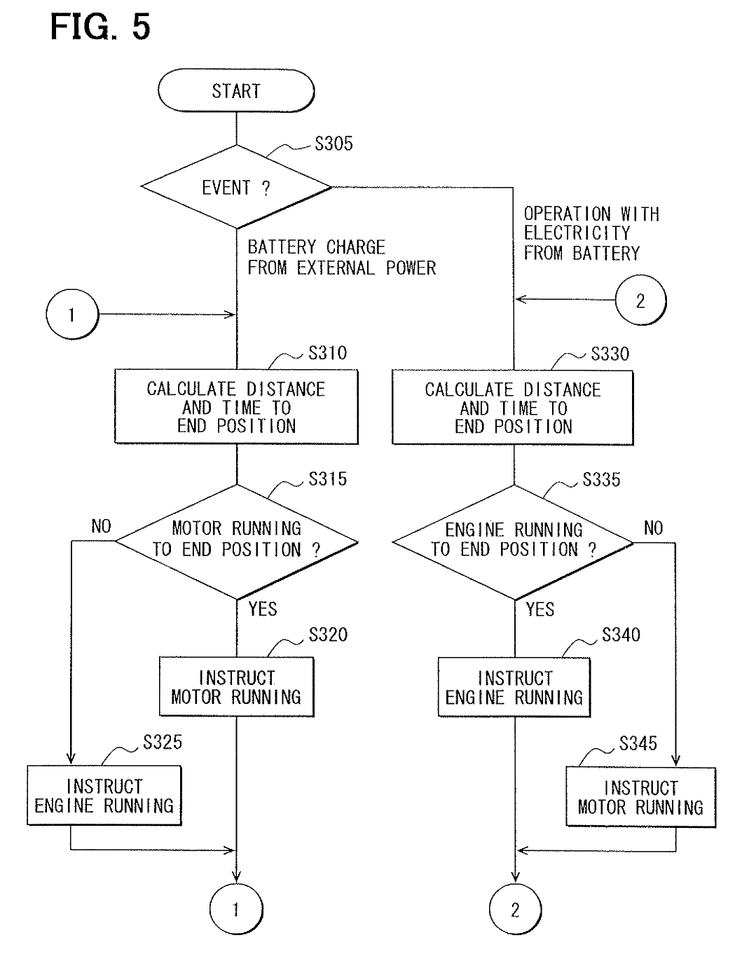

As follows, the first engine-motor switching processing will be described with reference to FIG. 5. The first engine-motor switching processing is executed when the occurrence time point of the event, which is registered by the user to decrease or increase the remaining battery capacity, is after the driving operation. The present first engine-motor switching processing is a subroutine called and executed from the engine-motor control processing. The present first engine-motor switching processing is terminated when the driving operation of the vehicle ends.

At S305, the control portion 16 refers to an information item, which is stored in the storage portion 14, for identifying the event. When the event is to charge the battery from the external power source after the driving operation, the control portion 16 proceeds the processing to S310. Alternatively, when the event is to perform a predetermined operation of a device in the vehicle with electricity supplied from the battery, the control portion 16 proceeds the processing to S330.

At S310, the control portion 16 identifies the present position of the vehicle on a map based on a detection signal of the position detection portion 17 and map data (geographical information), which is inputted from the map data input portion 15. The control portion 16 further predicts a path from the present position to a driving end position, which is stored in the storage portion 14 as an additional information item, based on the map data. Subsequently, the control portion 16 calculates a travel distance from the present position of the vehicle to the driving end position based on the predicted path. Thus, the control portion 16 proceeds the processing to S315.

At S315, the control portion 16 communicates with the battery control ECU 30 via the in-vehicle LAN communication portion 18 and identifies the remaining battery capacity. In addition, the control portion 16 determines whether the battery has electricity enough to perform a motor running operation only with the motor as a power source while suspending the engine operation from the present position to the driving end position. The control portion 16 performs the present determination based on the travel distance to the driving end position calculated in S310. When the control portion 16 determines that the battery has electricity enough to perform the motor running operation, a positive determination is made at S315. Thus, the control portion 16 proceeds the processing to S320. Alternatively, when the control portion 16 determines that the battery does not have electricity enough to perform the motor running operation, a negative determination is made at S315. Thus, the control portion 16 proceeds the processing to S325.

At S320, the control portion 16 instructs the motor running operation to the hybrid ECU 20 via the in-vehicle LAN communication portion 18 and proceeds the processing to S310. The control portion 16 proceeds the processing to S325 when determining that electricity for the motor running operation cannot be supplied. At S325, the control portion 16 instructs an engine running operation to the hybrid ECU 20 via the in-vehicle LAN communication portion 18 so as to drive the vehicle only with the engine as a power source while suspending the motor operation. Thus, the control portion 16 proceeds the processing to S310.

When the event is to perform a predetermined operation by decreasing, i.e., consuming the remaining battery capacity, the control portion 16 proceeds the processing to S330. At S330, the control portion 16 identifies the present position of the vehicle on the map based on the detection signal of the position detection portion 17 and the map data, which is inputted from the map data input portion 15. The control portion 16 further predicts a path from the present position to a driving end position, which is stored in the storage portion 14 as an additional information item, based on the map data. Subsequently, the control portion 16 calculates a travel distance from the present position of the vehicle to the driving end position based on the predicted path. Thus, the control portion 16 proceeds the processing to S335.

At S335, the control portion 16 communicates with the fuel control ECU 40 via the in-vehicle LAN communication portion 18 and identifies remaining fuel of the engine. In addition, the, control portion 16 determines whether the remaining fuel is enough to perform the engine running operation from the present position to the driving end position based on the travel distance calculated in S330. When the control portion 16 determines that the remaining fuel is enough to perform the engine running operation, a positive determination is made at S335. Thus, the control portion 16 proceeds the processing to S340. Alternatively, when the control portion 16 determines that the remaining fuel is not enough to perform the engine running operation, a negative determination is made at S335. Thus, the control portion 16 proceeds the processing to S345.

At S340, the control portion 16 instructs the engine running operation to the hybrid ECU 20 via the in-vehicle LAN communication portion 18 and proceeds the processing to S330. It is noted that the control portion 16 may further instruct the hybrid ECU 20 to increase output power of the engine so as to further drive the generator and increase electricity caused by the generator.

The control portion 16 proceeds the processing to S345 when determining that the engine running operation cannot be performed with the remaining fuel. At S345, the control portion 16 instructs the motor running operation to the hybrid ECU 20 via the in-vehicle LAN communication portion 18. Thus, the control portion 16 proceeds the processing to S330.

(4) Second Engine-Motor Switching Processing

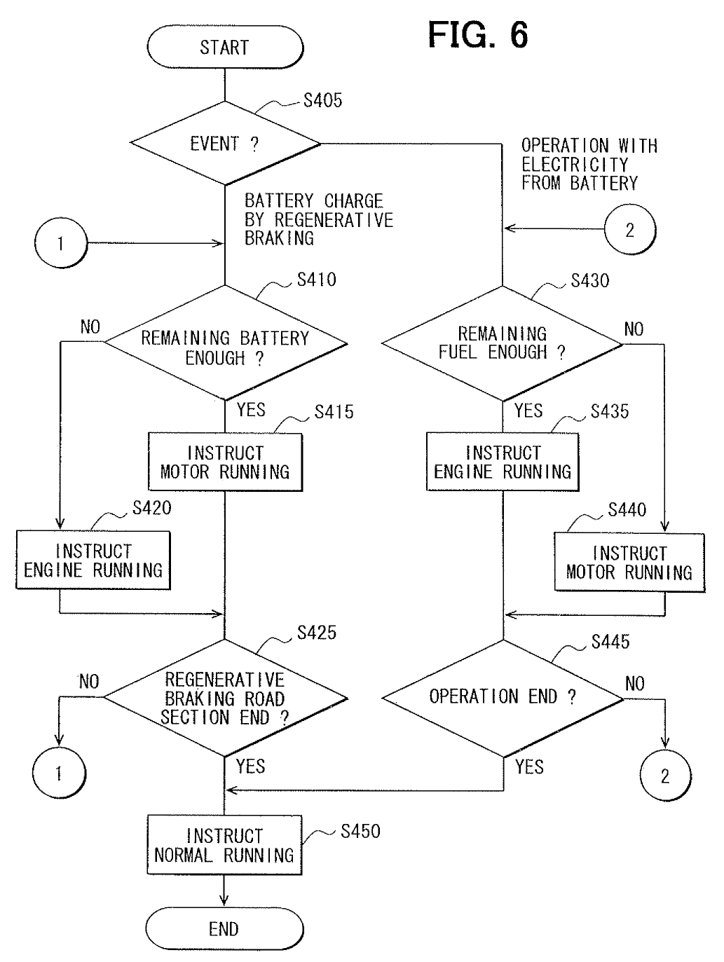

As follows, a second engine-motor switching processing will be described with reference to FIG. 6. The second engine-motor switching processing is executed when the occurrence time point of the event, which is registered by the user to decrease or increase the remaining battery capacity, is in the driving operation. The present second engine-motor switching processing is a subroutine called and executed from the engine-motor control processing.

At S405, the control portion 16 refers to the information item, which is stored in the storage portion 14, for identifying the event. When the event is to charge the battery by performing regenerative braking of the motor in a predetermined road section, the control portion 16 proceeds the processing to S410. Alternatively, when the event is to perform a predetermined operation of a device in the vehicle with electricity supplied from the battery, the control portion 16 proceeds the processing to S430.

At S410, the control portion 16 communicates with the battery control ECU 30 via the in-vehicle LAN communication portion 18 and identifies the remaining battery capacity. When the remaining battery capacity is greater than or equal to a predetermined value, a positive determination is made at S410. In this case, the control portion 16 determines the remaining battery capacity to be enough and proceeds the processing to S415. Alternatively, when the remaining battery capacity is less than the predetermined value, a negative determination is made at S410. In this case, the control portion 16 determines the remaining battery capacity not to be enough and proceeds the processing to S420.

At S415, the control portion 16 instructs the motor running operation to the hybrid ECU 20 via the in-vehicle LAN communication portion 18a and proceeds the processing to S425. In the present motor running operation, the engine is suspended and only the motor is used as the power source.

When the remaining battery capacity is not enough, the control portion 16 proceeds the processing to S420. At S420, the control portion 16 instructs the engine running operation to the hybrid ECU 20 via the in-vehicle LAN communication portion 18 and proceeds the processing to S425. In the present engine running operation, the motor is suspended and only the engine is used as the power source.

At S425, the control portion 16 identifies the present position of the vehicle on the map based on the detection signal of the position detection portion 17 and the map data, which is inputted from the map data input portion 15. Thus, the control portion 16 determines whether the present position of the vehicle is at the end point of the road section, in which the regenerative braking is performed, with reference to the additional information of the event stored in the storage portion 14. When the present position of the vehicle is at the end point of the road section, in which the regenerative braking is performed, a positive determination is made at S425. In this case, the control portion 16 determines the running operation in the road section, in which the regenerative braking is performed, to be completed and proceeds the processing to S450. Alternatively, when the present position of the vehicle is not at the end point of the road section, in which the regenerative braking is performed, a negative determination is made at S425. In this case, the control portion 16 proceeds the processing to S410.

When the event is to perform a predetermined operation of a device in the vehicle with electricity supplied from the battery, the control portion 16 proceeds the processing to S430. At S430, the control portion 16 communicates with the fuel control ECU 40 via the in-vehicle LAN communication portion 18 and identifies the remaining fuel of the engine. When the remaining fuel is less than or equal to a predetermined value, a positive determination is made at S430. In this case, the control portion 16 determines the remaining fuel to be enough and proceeds the processing to S435. Alternatively, when the remaining fuel is less than the predetermined value, a negative determination is made at S430. In this case, the control portion 16 determines the remaining fuel not to be enough and proceeds the processing to S440.

At S435, the control portion 16 instructs the engine running operation to the hybrid ECU 20 via the in-vehicle LAN communication portion 18 and proceeds the processing to S445. It is noted that the control portion 16 may further instruct the hybrid ECU 20 to increase output power of the engine so as to further drive the generator and increase electricity caused by the generator.

When the remaining fuel is not enough, the control portion 16 proceeds the processing to S440. At S440, the control portion 16 instructs the motor running operation to the hybrid ECU 20 via the in-vehicle LAN communication portion 18 and proceeds the processing to S445.

At S445, the control portion 16 identifies the device, which performs the predetermined operation, with reference to the additional information stored in the storage, portion 14. Further, the control portion 16 communicates with the device, which performs the predetermined operation, via the in-vehicle LAN communication portion 18 and thereby determines whether the predetermined operation, which relates to the event, is completed. When the control portion 16 determines the predetermined operation to be completed, a positive determination is made at S445, and the control portion 16 proceeds the processing to S450. Alternatively, when the control portion 16 determines the predetermined operation not to be completed, a negative determination is made at S445, and the control portion 16 proceeds the processing to S430.

When the event such as the regenerative braking or the predetermined operation is completed, the processing proceeds to S450. At S450, the control portion 16 instructs the normal running to the hybrid ECU 20 via the in-vehicle LAN communication portion 18. Finally, the control portion 16 terminates the present processing.

(Effect)

The navigation device 10 receives the event from a user to decrease or increase the remaining battery capacity and registers the event (S105). The navigation device 10 further controls the output power of the motor and the engine according to the registered event. Therefore, the remaining battery capacity at the time point, at which the registered event occurs, or in the course of the registered event can be appropriately controlled according to the event. In addition, convenience of the navigation device 10 can be enhanced by receiving the registration of the event from a user.

Specifically, the navigation device 10 executes the following processing when an event to charge the battery from an external power source after a driving operation is registered. When the remaining battery capacity is enough to perform the motor running operation of the vehicle from the present position to the driving end position (S315: Yes), the navigation device 10 instructs the hybrid ECU 20 to perform the motor running operation (S320). Alternatively, when the remaining battery capacity is not enough to perform the motor running operation of the vehicle from the present position to the driving end position (S315: No), the navigation device 10 instructs the hybrid ECU 20 to perform the engine running operation (S325). According to the present operation, the motor running operation is performed after a time point, at which the travel distance between the present position of the vehicle and the driving end position becomes equal to or less than the predetermined value, until a time point, at which the vehicle reaches the driving end position. Thus, in a condition where the travel distance to the driving end position is suitable, the remaining battery capacity can be consumed substantially to zero by a time point at which the battery is to be charged. That is, the motor running operation only using the motor as the power source or a running operation mainly using the motor output power can be performed with expectation of the battery charge. Thus, the remaining battery capacity can be reduced as much as possible before the expected battery charge. In addition, a running operation without the engine output power or a running operation with the engine output power as an auxiliary power source can be performed to the driving end position. Therefore, consumption of the remaining fuel of the engine can be reduced or restricted. Thus, supplying work of fuel and cost for supplying fuel can be reduced.

Alternatively, the navigation device 10 executes the following processing when an event to perform the predetermined operation of the device in the vehicle with electricity supplied from the battery after a driving operation is registered. When the remaining fuel is enough to perform the engine running operation of the vehicle from the present position to the driving end position (S335: Yes), the navigation device 10 instructs the hybrid ECU 20 to perform the engine running operation (S340). Alternatively, when the remaining fuel is not enough to perform the engine running operation of the vehicle from the present position to the driving end position (S335: No), the navigation device 10 instructs the hybrid ECU 20 to perform the motor running operation (S345). According to the present operation, the engine running operation is performed after a time point, at which the travel distance between the present position of the vehicle and the driving end position becomes equal to or less than the predetermined value, until a time point, at which the vehicle reaches the driving end position. Thus, the engine running operation is constantly performed to the driving end position on condition of the travel distance from a start position to the driving end position. Therefore, the engine running operation only using the engine as the power source or a running operation mainly using the engine output power can be performed. Thus, consumption of the remaining battery capacity caused by driving of the motor can be constrained until the vehicle reaches the driving end position in dependence upon the travel distance. In addition to the instruction to perform the engine running operation, the navigation device 10 may further instruct to increase the output power of the engine so as to drive the generator and generate electricity using the generator. In this case, the remaining battery capacity can be increased. In the present operation, the remaining battery capacity can be reserved as much as possible for execution of the predetermined operation of the device. Furthermore, only when the travel distance between the present position of the vehicle and the driving end position is greater than the predetermined distance, a running operation with the motor as the power source is performed. Accordingly, even when the remaining fuel of the engine is not enough, the running operation of the vehicle can be maintained with the motor output power.

Furthermore, when the event to charge the battery by the regenerative braking of the motor in the predetermined road section is registered, the navigation device 10 executes the following processing until the running operation in the road section, in which the regenerative braking is performed, is completed. When the remaining battery capacity is greater than or equal to the predetermined value (S410: Yes), the navigation device 10 instructs the hybrid ECU 20 (S415) to perform the motor running operation. Alternatively, when the remaining battery capacity is less than the predetermined value (S410: Yes), the navigation device 10 instructs the hybrid ECU 20 (S420) to perform the engine running operation. In the present operation, the motor running operation only using the motor as the power source or a running operation mainly using the motor output power can be performed with expectation of the regenerative braking and the battery charge. Thus, the remaining battery capacity can be reduced as much as possible before the regenerative braking and the battery charge. Further, the running operation using the engine as a power source can be performed only when the remaining battery capacity is not enough. In the present operation, a running operation while the engine is stopped or a running operation with the engine output power as an auxiliary power source can be performed. Thereby, consumption of the remaining fuel of the engine can be reduced or restricted. Thus, supplying work of fuel and cost for supplying fuel can be reduced;

Alternatively, the navigation device 10 performs the following processing when an event to perform the predetermined operation of the device in the vehicle with electricity supplied from the battery in the driving operation is registered. When the remaining fuel is greater than or equal to the predetermined value (S430: Yes), the navigation device 10 instructs the hybrid ECU 20 (S435) to perform the engine running operation. Alternatively, when the remaining fuel is less than the predetermined value (S430: Yes), the navigation device 10 instructs the hybrid ECU 20 (S440) to perform the motor running operation. Therefore, the engine running operation only using the engine as the power source or a running operation mainly using the engine output power can be performed until the device starts the predetermined operation. Thus, consumption of the remaining battery capacity caused by driving of the motor can be constrained on condition that the engine does not run out of the remaining fuel. In addition to the instruction to perform the engine running operation, the navigation device 10 may further instruct to increase the output power of the engine so as to drive the generator and generate electricity using the generator. In this case, the remaining battery capacity can be increased. In the present operation, the remaining battery capacity can be reserved as much as possible for the predetermined operation of the device. In addition, even when the engine runs out of the remaining fuel, the running operation of the vehicle can be maintained with the motor as a power source.

### Other Embodiment

(1) At S320 of the first engine-motor switching processing or at S415 of the second engine-motor switching processing, the navigation device 10 instructs the hybrid ECU 20 to perform the motor running operation, in which the engine is suspended, and only the motor is used as the power source. Alternatively, at S320 or S415, the navigation device 10 may provide a motor-priority running instruction to the hybrid ECU 20 so as to increase a workload of the motor and decrease a workload of the engine relative to a normal running operation. In this case, the engine operation is maintained. Specifically, in the motor-priority running, the hybrid ECU 20 may increase an operation frequency of the motor and decrease an operation frequency of the engine, compared with the normal running operation. In the motor-priority running, the hybrid ECU 20 may drive a driving wheel by using both the engine output power and the motor output power with decreasing the engine output power and increasing the motor output power, compared with the normal running operation. According to the present operation, a workload of the engine can be reduced, and a workload of the motor can be increased, compared with the normal running operation. Thus, the remaining battery capacity can be reduced as much as possible before the battery charge, and reduction in the remaining fuel of the engine can be constrained. Further, shortage of the motor output power can be compensated with the engine output power when a driving wheel is driven by using both the engine output power and the motor output power in the motor-priority running. Therefore, sufficient output power for the running operation of the vehicle can be obtained, and the driving comfort can be enhanced.

(2) At S340 of the first engine-motor switching processing or at S435 of the second engine-motor switching processing, the navigation device 10 instructs the hybrid ECU 20 to perform the engine running operation, in which the motor is suspended, and only the engine is used as the power source. Alternatively, at S340 or S435, the navigation device 10 may provide an engine-priority running instruction to the hybrid ECU 20 so as to decrease a workload of the motor and increase a workload of the engine relative to a normal running operation. In this case, the motor operation is maintained. Specifically, in the engine-priority running, the hybrid ECU 20 may decrease an operation frequency of the motor and increase an operation frequency of the engine, compared with the normal running operation. In the engine-priority running, the hybrid ECU 20 may drive a driving wheel by using both the engine output power and the motor output power with increasing the engine output power and decreasing the motor output power, compared with the normal running operation. According to the present operation, a workload of the motor can be decreased, and a workload of the engine can be increased, compared with the normal running operation. Thus, reduction in the remaining battery capacity can be constrained, and thereby the remaining battery capacity can be reserved as much as possible. Further, shortage of the engine output power can be compensated with the motor output power when a driving wheel is driven by using both the engine output power and the motor output power in the engine-priority running. Therefore, sufficient output power for the running operation of the vehicle can be obtained, and the driving comfort can be enhanced.

(3) As described above, in the second engine-motor switching processing, when an event to perform the predetermined operation of the device in the vehicle with electricity supplied from the battery is registered, the navigation device 10 provides an instruction to the hybrid ECU 20 so as to perform a normal running operation after completion of the predetermined operation. It is noted that, the remaining battery capacity may be sufficiently greater than a battery capacity, which is to be consumed by supplying electricity for executing the predetermined operation of the device. In this case, the navigation device 10 may provide an instruction to the, hybrid ECU 20 so as to perform the normal running operation before executing the predetermined operation or in the course of the predetermined operation, for example.

(4) In the above embodiment, the navigation device 10 controls the motor output power and the engine output power based on an event, which is registered by the user to decrease or increase the remaining battery capacity. It is noted that a user may set a home or the like as a destination (driving end point). In this case, the navigation device 10 may register an event to charge the battery from an external power source after completion of a driving operation as an event to increase the remaining battery capacity, for example. It is noted that the navigation device 10 may receive an instruction to download map data, which is a geographical information item, from an external device via the external communication device 19, for example. In this case, the download of the map data may be registered in the navigation device 10 as an event to decrease the remaining battery capacity. According to the present structure, convenience of the navigation device 10 can be further enhanced.

(5) In the above embodiment, the navigation device 10 is mounted in the hybrid vehicle in which both the engine and the motor drive a driving wheel. It is noted that the navigation device 10 may be applied to a series hybrid vehicle in which a motor drives a driving wheel while a generator charges a battery, which supplies electricity to the motor. In this case, when an event to charge a battery is registered, the navigation device 10 may provide an instruction to a device for controlling a motor so as to increase a workload of the motor thereby to accelerate consumption of the remaining battery capacity in the series hybrid vehicle. Alternatively, when an event to perform a predetermined operation of a device in the vehicle with electricity supplied from the battery is registered, the navigation device 10 may provide an instruction to the device for controlling the motor so as to decrease a workload of the motor thereby to restrict decrease in the remaining battery capacity. In addition, the navigation device 10 may further provide an instruction to a device for controlling the engine so as to increase a workload of the engine thereby to further generate electricity using the generator driven by the engine. According to the present structure, reduction in the remaining battery capacity can be restricted, and thereby the remaining battery capacity can be increased. Thus, the remaining battery capacity can be appropriately controlled in response to an event to decrease or increase the remaining battery capacity.

The navigation device 10 is equivalent to an in-vehicle device. The hybrid ECU 20 is equivalent to an external device, which controls an output power of a motor, and an external device, which controls an output power of an engine. The control portion 16 is equivalent to an event identifying means. The control portion 16 and the in-vehicle LAN communication portion 18 are equivalent to a control instruction means. S305 in the first engine-motor switching processing and S405 in the second engine-motor switching processing are equivalent to an event identifying processing. S320, S340 in the first engine-motor switching processing and S415, S435 in the second engine-motor switching processing are equivalent to a control instruction processing.

In the embodiment, the in-vehicle device is provided in a vehicle, which includes a battery and a motor. The motor drives a driving wheel by supplied with electric power from the battery. The in-vehicle device includes event identifying means and control instruction means. The event identifying means identifies an event before the event occurs. The event is to decrease or increase a remaining capacity of the battery in a driving operation of the vehicle or after completion of the driving operation. The control instruction means provides an instruction to an external device for controlling an output power and a workload of the motor according to the identified event after the event identifying means identifies the event and before the event ends at the latest. The vehicle includes at least a motor for driving a driving wheel. For example, the vehicle may only have a motor as a power source or may be a hybrid vehicle, which has a motor and an engine as power sources.

The event to manipulate the remaining capacity of the battery may be an operation performed by the device by consuming electricity supplied from the battery or may be an operation to charge the battery from an external power source, for example. The control instruction means may provide an instruction to control the workload of the motor by, for example, providing an instruction to control the output power of the motor. For example, the in-vehicle device may be provided in the hybrid vehicle, which selects either an engine or a motor according to a condition and drives a driving wheel using the selected engine or motor. In this case, the control instruction means may provide an instruction to control an operation frequency of the motor and thereby to provide an instruction to control the workload of the motor. Thus, when the in-vehicle device identifies the predetermined event to decrease the remaining battery capacity, for example, the in-vehicle device continues running of the vehicle while reducing electric consumption of the motor until the predetermined event is completed at the latest. Therefore, reduction in the remaining battery capacity can be constrained to secure the remaining battery capacity, which is required for the predetermined event when the predetermined event is started or in the predetermined event. Thus, when the in-vehicle device identifies the predetermined event to increase the remaining battery capacity, for example, the in-vehicle device continues running of the vehicle while increasing output power of the motor until the predetermined event is completed at the latest. In short, electricity supply from the battery to the motor is increased with expectation of the battery charge, and thereby the motor output power can be increased. Thus, the driver can operate the vehicle with comfort. Thus, reduction in the remaining battery capacity caused by the running operation can be controlled according to the driving condition. Thereby, the remaining battery capacity can be appropriately controlled in the beginning of the predetermined event or in the predetermined event.

Furthermore, when the battery is to be charged from an external power source after the driving operation, for example, consumption of fuel may be preferably reduced as much as possible in view of supplying work of fuel and cost for the work. Therefore, the in-vehicle device may be provided in a hybrid vehicle, which includes a battery, a motor, and an engine. The engine is for driving at least one of a generator, which is for charging a battery, and a driving wheel. The control instruction means provides an instruction to an external device, which controls the engine output power, so as to control a workload of the engine, according to the predetermined event identified by the event identifying means.

The hybrid vehicle may be one of a series hybrid, a parallel hybrid vehicle, and a power-split hybrid vehicle. In a series hybrid vehicle, a motor drives a driving wheel while an engine drives a generator to charge a battery, which is for supplying electricity to the motor. In a parallel hybrid vehicle or a power-split hybrid vehicle, both a motor and an engine drive a driving wheel.

The control instruction means may provide an instruction to control the workload of the engine by, for example, providing an instruction to manipulate the rotation speed of the engine so as to control the output power of the engine. For example, the in-vehicle device may be provided in the hybrid vehicle, which selects either an engine or a motor according to a condition and drives a driving wheel using the selected engine or motor. In this case, the control instruction means may provide an instruction to control an operation frequency of the engine and thereby to provide an instruction to control the workload of the engine. Thus, when the in-vehicle device identifies the predetermined event to decrease the remaining battery capacity, for example, the in-vehicle device continues running of the vehicle while reducing a workload of the motor and increasing a workload of the engine until the predetermined event is completed at the latest. Further, shortage of the motor output power can be compensated with the engine output power when a driving wheel is driven by using both the engine output power and the motor output power in the hybrid vehicle. Thus, the driver can operate the vehicle with comfort, while restricting reduction in the remaining battery capacity. Alternatively, when the in-vehicle device is provided in a hybrid vehicle, in which an engine drives a generator, for example, reduction in the remaining battery capacity can be restricted, or the remaining battery capacity can be increased by enhancing an engine workload so as to increase electricity generated using a generator. Thereby, the remaining battery capacity can be controlled in the beginning of a predetermined event or in the predetermined event. Thus, when the in-vehicle device identifies the predetermined event to increase the remaining battery capacity, for example, the in-vehicle device continues running of the vehicle while increasing a workload of the motor and decreasing a workload of the engine until the predetermined event is completed at the latest. Thereby, consumption of fuel can be reduced. Thus, supplying work of fuel and cost for supplying fuel can be reduced. Further, shortage of the engine output power can be compensated with the motor output power when a driving wheel is driven by using both the engine output power and the motor output power in the hybrid vehicle. Thus, the driver can operate the vehicle with comfort, while restricting reduction in the remaining fuel.

The in-vehicle device may identify the predetermined event as follows.

The event identifying means may identify a predetermined operation of the device, which is performed with electricity supply from the battery, as the event to decrease the remaining battery capacity in the driving operation or after completion of the driving operation. In the present operation, for example, when a device, which is supplied with electricity from the same battery as a motor, requires a large amount of electricity or the device performs a specific operation after completion of a driving operation or the like, the remaining battery capacity can be secured as much as possible for the operation.

More specifically, the predetermined events may be the following operation.

The event identifying means may identify an operation of an external device to download data from an external source with electricity supply from the battery, as the event to decrease the remaining battery capacity in the driving operation or after completion of the driving operation. In the present operation, the remaining battery capacity can be reserved as much as possible for the download operation of the device with electricity supply from the same battery as the motor in the driving operation or after completion of the driving operation.

When the in-vehicle device identifies the predetermined event to decrease the remaining battery capacity, the in-vehicle device may control the workload of the motor, as follows.

The control instruction means may provide an instruction to an external device for decreasing the workload of the motor after the event identifying means identifies the event to decrease the remaining battery capacity and before the event ends at the latest. In the present operation, when the in-vehicle device identifies the predetermined event to decrease the remaining battery capacity, for example, the in-vehicle device continues running of the vehicle while reducing electric consumption of the motor until the predetermined event is completed at the latest. Thus, reduction in the remaining battery capacity can be restricted, and the remaining battery capacity can be appropriately set in the beginning of the predetermined event or in the predetermined event.

The in-vehicle device may decrease the workload of the motor, as follows.

The control instruction means may provide an instruction to an external device to stop the motor so as to reduce the workload of the motor after the event identifying means identifies the event to decrease the remaining battery capacity and before the event ends at the latest. In the present operation, when the in-vehicle device identifies the predetermined event to decrease the remaining battery capacity, reduction in the battery remaining capacity due to an operation of the motor can be restricted until the predetermined event is completed at the latest. Thus, reduction in the remaining battery capacity can be restricted, and the remaining battery capacity can be appropriately set in the beginning of the predetermined event or in the predetermined event.

It is noted that the motor output power may excessively decrease due to reduction in the workload of the motor in response to the identification of the predetermined event to decrease the remaining battery capacity. Consequently, the driving force of the vehicle may become insufficient.

In view of the present problem, the control instruction means may provide an instruction to an external device for increasing the workload of the engine after the event identifying means identifies the event to decrease the remaining battery capacity and before the event ends at the latest. In the present structure, the in-vehicle device can operate the hybrid vehicle, in which both a motor and an engine drive a driving wheel, mainly using the engine output power after the event is identified and before the event ends at the latest. Therefore, the vehicle can be driven while insufficiency of the motor output power is compensated with the engine output power, and thereby the driving operation can be made comfort, while reduction in the remaining battery capacity is restricted. Alternatively, the in-vehicle device in a hybrid vehicle, in which an engine drives a generator, for example, can restrict reduction in the remaining battery capacity or increase the remaining battery capacity by enhancing an engine work load so as to increase electricity generated using a generator, after the event is identified and before the event ends at the latest. Thereby, the remaining battery capacity can be increased as much as possible in the beginning of the predetermined event or in the predetermined event.

The in-vehicle device may identify the predetermined event as follows.

The event identifying means may identify charge of the battery from an external power source as the event to increase the remaining battery capacity. In the present operation, the in-vehicle device can increase electricity consumed by the motor and decrease the remaining battery capacity as much as possible with expectation of battery charge when the battery is to be charged.

When the in-vehicle device identifies the predetermined event to increase the remaining battery capacity, the in-vehicle device may control the workload of the motor, as follows.

The control instruction means may provide an instruction to an external device for increasing the workload of the motor after the event identifying means identifies the event to increase the remaining battery capacity and before the event ends at the latest. In the present operation, when the predetermined event to increase the remaining battery capacity is identified, the remaining battery capacity can be reduced as much as possible by increasing electricity consumption of the motor with expectation to increase the remaining battery capacity.

When the in-vehicle device identifies the predetermined event to increase the remaining battery capacity, the in-vehicle device may control the workload of the engine, as follows.

The control instruction means may provide an instruction to an external device for decreasing the workload of the engine after the event identifying means identifies the event to increase the remaining battery capacity and before the event ends at the latest. In the present structure, fuel consumption for driving the engine can be restricted after the predetermined event is identified and before the predetermined event is completed at the latest. Thus, supplying work of fuel and cost for supplying fuel can be reduced. In addition, the in-vehicle device can operate the hybrid vehicle, in which both a motor and an engine drive a driving wheel, mainly using the motor output power after the event is identified and before the event ends at the latest. Therefore, the vehicle can be driven while insufficiency of the engine output power is compensated with the motor output power, and thereby the driving operation can be made comfort, while reduction in the remaining fuel is restricted.

The in-vehicle device may decrease the workload of the engine, as follows.

The control instruction means may provide an instruction to an external device for decreasing the workload of the engine by stopping the engine after the event identifying means identifies the event to increase the remaining battery capacity and before the event ends at the latest. In the present operation, when the in-vehicle device identifies the predetermined event to increase the remaining battery capacity, reduction in remaining fuel of the engine can be restricted until the predetermined event is completed at the latest. Thus, reduction in the remaining fuel of the engine can be further restricted.

The in-vehicle device may receive setting of the predetermined event from a user (occupant). That is, the in-vehicle device may further include a receiving means for receiving the setting of the event from an occupant. In the present structure, convenience of the in-vehicle device can be further enhanced.

According the embodiment, a program includes instructions stored in a computer readable medium and executed by a computer. The program is executed by an in-vehicle device for a vehicle, which includes a motor configured to be supplied with electricity from a battery and drive a driving wheel. The computer executes the program including event identifying step and control instruction step. The event identifying step identifies an event before the event occurs. The event is to decrease or increase a remaining battery capacity in a driving operation of the vehicle or after completion of the driving operation. The control instruction step provides an instruction to an external device for controlling an output power and a work load of the motor according to the identified event after the event identifying means identifies the event and before the event ends at the latest.

The program may be stored in the computer readable medium such as a magneto-optical disc, a CO-ROM, a hard disk, a semiconductor device such as a ROM, a RAM. The program may be arbitrary loaded in a computer and executed to perform the operation of the in-vehicle device. The program may be distributed via a network, and thereby the function of the in-vehicle device can be easily enhanced.

The above processings such as instructions and determinations may be performed by any one or any combinations of software, an electric circuit, a mechanical device, and the like. The electric circuit may be an integrated circuit, and may be a discrete circuit such as a hardware logic configured with electric or electronic elements or the like. The elements producing the above processings may be discrete elements and may be partially or entirely integrated. The above processings such as calculations and determinations are not limited being executed by the ECU devices 10,20,30,40. The control unit may have various structures including, the ECU devices 10,20,30,40 shown as an example. It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. An in-vehicle device for a vehicle, which includes a motor supplied with electricity from a battery for driving a driving wheel, the in-vehicle device comprising:
event identifying means for identifying an event before the event occurs, the event being to decrease or increase a remaining capacity of the battery in the course of a driving operation of the vehicle or after the driving operation; and
control instruction means for providing an instruction to an external control device to control an output power and a workload of the motor according to the identified event before the event ends at the latest.

2. The in-vehicle device according to claim 1,
wherein the vehicle is a hybrid vehicle, which includes the battery, the motor, and an engine for driving at least one of a generator, which is for charging the battery, and a driving wheel, and
the control instruction means is configured to provide an instruction to the external control device to control an output power and a workload of the engine according to the identified event.

3. The in-vehicle device according to claim 1, wherein the event identifying means is configured to identify a predetermined operation, which is performed by an event device with consumption of electricity supplied from the battery, as the event to decrease the remaining battery capacity in the course of the driving operation or after the driving operation.

4. The in-vehicle device according to claim 3, wherein the event identifying means is configured to identify an operation, which is performed by the event device to download data from an external source with consumption of electricity supplied from the battery, as the event to decrease the remaining battery capacity in the course of the driving operation or after the driving operation.

5. The in-vehicle device according to claim 1, wherein the control instruction means is configured to provide an instruction to the external control device to decrease the workload of the motor after the event identifying means identifies the event to decrease the remaining battery capacity and before the event ends at the latest.

6. The in-vehicle device according to claim 5,
wherein the vehicle is a hybrid vehicle, which includes the battery, the motor, and an engine for driving a driving wheel, and
the control instruction means is configured to provide an instruction to the external control device to decrease the workload of the motor by suspending an operation of the motor after the event identifying means identifies the event to decrease the remaining battery capacity and before the event ends at the latest.

7. The in-vehicle device according to claim 2, wherein the control instruction means is configured to provide an instruction to the external control device to increase the workload of the engine after the event identifying means identifies the event to decrease the remaining battery capacity and before the event ends at the latest.

8. The in-vehicle device according to claim 1, wherein the event identifying means identifies charge of the battery from an external power source as the event to increase the remaining battery capacity.

9. The in-vehicle device according to claim 1, wherein the control instruction means is configured to provide an instruction to the external control device to increase the workload of the motor after the event identifying means identifies the event to increase the remaining battery capacity and before the event ends at the latest.

10. The in-vehicle device according to claim 2, wherein the control instruction means is configured to provide an instruction to the external control device to decrease the workload of the engine after the event identifying means identifies the event to increase the remaining battery capacity and before the event ends at the latest.

11. The in-vehicle device according to claim 10, wherein the control instruction means is configured to provide an instruction to the external control device to decrease the workload of the engine by suspending an operation of the engine after the event identifying means identifies the event to increase the remaining battery capacity and before the event ends at the latest.

12. The in-vehicle device according to claim 1, further comprising:
receiving means for receiving the event from an occupant.

13. A computer readable medium comprising instructions being executed by a computer, which is provided in an in-vehicle device for a vehicle, which includes a motor supplied with electricity from a battery for driving a driving wheel, the instructions including a method comprising:
identifying an event beforehand, the event being to decrease or increase a remaining capacity of the battery in the course of a driving operation of the vehicle or after the driving operation; and
providing an instruction to an external control device to control an output power and a workload of the motor according to the identified event before the event ends at the latest.
